(19) United States
(12) Patent Application Publication
(10) Pub. No.: US 2010/0275252 A1
(43) Pub. Date: Oct. 28, 2010

(54) Software management apparatus and method, and user terminal controlled by the apparatus and management method for the same

(75) Inventor: Yong Yun, Seoul (KR)

Correspondence Address: BACON & THOMAS, PLLC, 625 SLATERS LANE, FOURTH FLOOR, ALEXANDRIA, VA, 22314-1176, US

(73) Assignee: GYEYEONG TECHNOLOGY & INFORMATION CO., LTD., Seoul (KR)

(21) Appl. No.: 12/662,345

(22) Filed: Apr. 13, 2010

(30) Foreign Application Priority Data
Apr. 13, 2009 (KR) 10-2009-0031988

(51) Int. Cl. G06F 17/30; H04L 9/32

(52) U.S. Cl. 726/7; 707/769; 707/E17.014

(57) ABSTRACT

A software management apparatus and method are disclosed. A software installation attempt made in one of multiple user terminals connected through a corporate network is detected, and a management operation is performed to permit software installation, to block the use of the user terminal, or to provide a popup notification according to the rights assigned to the user terminal. In addition, unlike existing approaches to prevention of unauthorized software installation that may not handle already installed software, the software management apparatus and method enable the system manager to handle and remove software that is already installed in a user terminal before installation of the apparatus and method. As a result, unauthorized installation of software in corporate computers can be effectively prevented.

### TECHNICAL FIELD

The present invention relates to an apparatus and method for software management, and more particularly, to a software management apparatus and method, and user terminals controlled by the apparatus and a management method for the same wherein, when unauthorized installation of software is attempted in one or more of the user terminals connected through a network, the attempt is detected and a management operation is performed to permit the attempt, to block the attempt, or to uninstall the software.

### BACKGROUND ART

In recent years, unauthorized installation of software on corporate computers and unauthorized use thereof by employees has caused various errors in the corporate computers, and may result in copyright infringement of software.

To prevent unauthorized installation of software, various schemes have been disclosed. In a widely known scheme, a software usage code that is created using a unique identification code of a computer is assigned to authorized software; and the software usage code is checked in real-time against the identification code of a computer executing the software. This scheme can invalidate license reproduction by unauthorized computers, and prevent unauthorized software use violating the license agreement.

In another scheme for preventing unauthorized software installation, license management is performed in a unitary manner by a central management apparatus connected through a network (licenses are not given to individual computers). In this scheme, when a user terminal on the network issues a software use request, the number of copies specified in the license agreement can be checked and the software use request may be permitted or denied according to the result. Hence, the number of computers simultaneously running the software and the software usage limit may be set, and unauthorized usage exceeding the limits may be blocked.

However, these existing schemes aim to limit utilization of software after installation and cannot prevent unauthorized installation of software. Prevention of unauthorized use of software can be crucial to promotion and protection of information technology industries, and there is a growing tendency to take legal action against unauthorized use of software. However, corporations may have difficulty in preventing unauthorized installation of software by employees, and may only make an effort to block unauthorized use of software after installation. Such a corporation may be subject to legal penalties in the case of surprise inspection for unauthorized installation and use of software.

### DETAILED DESCRIPTION OF THE INVENTION

In order to solve the aforementioned problems, an object of the present invention is to provide a software management apparatus and method, and user terminals controlled by the apparatus and management method for the same wherein a software installation attempt made in a user terminal connected to a network is detected, and a management operation is performed to permit software installation and utilization or to block the attempt according to the rights assigned to the user terminal.

Another object of the present invention is to provide a software management apparatus and method, and user terminals controlled by the apparatus and management method for the same that may uninstall a selected piece of installed software.

Another object of the present invention is to provide a software management apparatus and method, and user terminals controlled by the apparatus and management method for the same wherein a software product that may be distributed as multiple pieces or a single package is managed as a group.

According to an aspect of the present invention, there is provided a software management method for a management apparatus controlling a plurality of user terminals, including: receiving an identification code and a unique key that is obtained by hashing software related to an installation attempt from a user terminal; determining whether to permit or prohibit installation of the software related to the installation attempt by comparing the identification code and unique key with management information; and controlling the user terminal to install or remove the software according to the determination.

The unique key may be a hash value obtained by applying a one-way hashing function to an installation file of the software.

The identification code may correspond to a hardware address (MAC) or a BIOS serial number of the user terminal.

The management information may include information regarding the type and quantity of software available for installation for each user terminal.

The software management method may further include: generating unique keys for multiple pieces of software to be managed, before receiving an identification code and a unique key from a user terminal; and storing the generated unique keys in a database.

Determining whether to permit or prohibit installation of the software related to the installation attempt may include: identifying the user terminal associated with the identification code; identifying the type of the software on the basis of the unique key; and checking whether to permit or prohibit installation of the software by comparing the identification results with the management information related to the user terminal.

Checking whether to permit or prohibit installation of the software may further include determining to permit installation of the software when the identified type indicates update.

The software management method may further include: receiving current installation information regarding already installed software from a user terminal; receiving a request for an uninstall list of software to be deleted from the user terminal and an identification code of the user terminal; and identifying the user terminal using the identification code, creating an uninstall list on the basis of the current installation information, and sending the uninstall list to the user terminal.

The current installation information may be periodically received, and the uninstall list may be sent and received through an HTTP POST method with UTF-8 character encoding.

The uninstall list may be an INI file that contains information regarding specific software including the sequence number, name, package identifier, and number of software items in the package.

Identifying the user terminal and creating an uninstall list may include: identifying the user terminal using the received identification code; creating an uninstall list of software to be deleted by comparing the management information related to the identified user terminal with the current installation information; and sending the created uninstall list to the user terminal.

According to another aspect of the present invention, there is provided a software management method for a user terminal that is controlled by a management apparatus, including: detecting a software installation attempt; generating an identification code of the user terminal and a unique key of software related to the installation attempt, and sending the identification code and unique key to the management apparatus; and installing the software related to the installation attempt or prohibiting the installation attempt according to control information from the management apparatus.

Generating an identification code and a unique key may include: detecting a process for installing the software; extracting an installation file of the software; and generating the unique key by hashing the installation file.

The software management method may further include displaying, when the installation attempt is prohibited, a notification popup indicating an installation abortion notification according to policy information from the management apparatus.

The software management method may further include: sending current installation information regarding already installed software to the management apparatus; sending a request for an uninstall list of software to be deleted and the identification code to the management apparatus; receiving an uninstall list corresponding to the current installation information from the management apparatus; and maintaining or removing the installed software according to the uninstall list.

The software management method may further include notifying the management apparatus of the result of software removal.

The software management method may further include: receiving policy information related to usage restriction from the management apparatus after maintaining or removing the installed software; and displaying a bluescreen to prohibit the use of the user terminal, or displaying a notification popup indicating prohibition of the use of the software according to the received policy information.

According to another aspect of the present invention, there is provided a software management apparatus for controlling a plurality of user terminals, including: a data transceiver module receiving an identification code and unique key from a user terminal, and sending control information for software installation permission or rejection to the user terminal; a terminal management module identifying a user terminal indicated by a received identification code and unique key, and determining whether to permit or block software installation; and a key comparison module comparing a unique key from a user terminal with management information stored in a database, and determining whether to permit or block software installation.

The terminal management module may include: a terminal recognizer identifying a user terminal by comparing the received identification code with terminal information stored in the database; and a setting manager determining the right for software installation assigned to the identified user terminal, and offering control information for controlling the user terminal according to the determination.

The database may include: a terminal information DB storing terminal information for identifying user terminals and information for software installation permission and rejection; a unique key DB storing unique keys of various software; and a policy information DB defining blocking levels of software.

The software management apparatus may further include a list generation module receiving a request for an uninstall list of software to be deleted through the data transceiver module, creating an uninstall list with reference to the database, and sending the uninstall list to the requesting user terminal.

According to another aspect of the present invention, there is provided a user terminal controlled by a management apparatus, including: an identification code generation module generating a unique identification code of the user terminal; an automatic scan module detecting a software installation attempt; a key generation module generating, upon detection of a software installation attempt, a unique key corresponding to the software related to the installation attempt; a data transceiver module sending the identification code and unique key to the management apparatus, and receiving control information for software installation permission or rejection from the management apparatus; and an installation control module permitting or blocking software installation according to the control information from the management apparatus.

The key generation module may include: a file extractor extracting an installation file of the software; and a hashing block generating the unique key by hashing the extracted installation file.

The hashing block generates the unique key using a one-way hashing function.

The user terminal of claim may further include a terminal control module that includes: a bluescreen provider blocking the use of the user terminal and providing a means for deleting the software; and a popup provider outputting a popup window indicating blocking the use of the software on the display screen.

The identification code may correspond to a hardware address (MAC) or a BIOS serial number of the user terminal.

The user terminal may further include an uninstallation handling module that includes: a list requester sending current installation information and a request for an uninstall list of software to be deleted to the management apparatus, receiving an uninstall list and identifying software to be deleted using the uninstall list; and a removal executor deleting the software identified by the list requester.

The uninstall list may be sent and received through an HTTP POST method with UTF-8 character encoding at a period of ten minutes.

The uninstall list may contain information regarding specific software including the sequence number, name, package identifier, and number of software items in the package.

In a feature of the present invention, a software installation attempt made in one of multiple user terminals connected through a corporate network is detected, and a management operation is performed to permit software installation, to block the use of the user terminal, or to provide a popup notification according to the rights assigned to the user terminal. Hence, unauthorized installation of software on corporate computers can be prevented.

Software that is already installed in a user terminal before activation of the agent program can be uninstalled according to the rights assigned to the user terminal. Hence, copyright infringement due to unauthorized installation of software may be prevented.

A software product is managed as a group, thereby solving the problem that an individual software installation in a user terminal may be misrecognized as a different product.

### BRIEF DESCRIPTION OF THE DRAWINGS

FIG. 1 illustrates the overall system constituting a software management apparatus according to an embodiment of the present invention;

FIG. 2 is a block diagram of a user terminal running a client agent according to an embodiment of the present invention;

FIG. 3 illustrates a bluescreen displayed on a blocked user terminal;

FIG. 4 illustrates a notification popup displayed on a user terminal with unauthorized software.

FIG. 5 is a block diagram of a management apparatus according to an embodiment of the present invention;

FIG. 6 is a representation of a blocking level setting screen provided by the management apparatus;

FIGS. 7 to 9 illustrate a management procedure for handling an attempt to install software in a user terminal according to an embodiment of the present invention;

FIGS. 10 and 11 illustrate a management procedure for handling software already installed in a user terminal according to an embodiment of the present invention;

FIGS. 12 and 13 illustrate a management procedure for handling an attempt to install software in a user terminal that is controlled by the management apparatus according to an embodiment of the present invention; and

FIGS. 14 and 15 illustrate a management procedure for handling software already installed in a user terminal that is controlled by the management apparatus according to an embodiment of the present invention.

### BEST MODE FOR CARRYING OUT THE INVENTION

Hereinafter, an exemplary embodiment of the present invention will be described in detail with reference to the accompanying drawings.

Software licensing policies may be grouped into a white policy and a black policy. In the white policy, use of licensed and registered software products is permitted, and use of other software products is blocked. In the black policy, use of registered software products is blocked, and use of other software products is permitted. The white policy enables easy blocking of many unregistered software products, however it may cause overly broad blocking (for example, even a program not requiring a license such as an Internet banking program may be blocked). The black policy may have advantages and disadvantages inverse to those of the white policy. In the present invention, the black policy and white policy may be employed selectively according to settings.

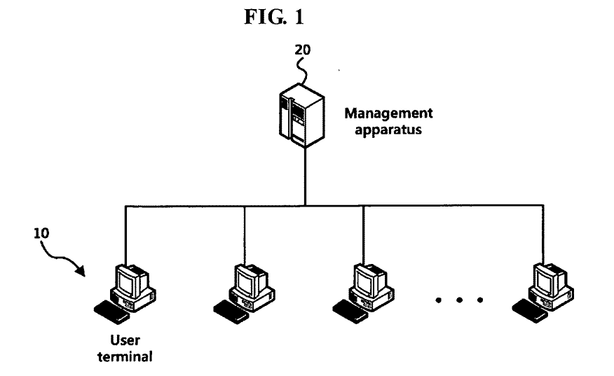

FIG. 1 illustrates the overall system constituting a software management apparatus according to an embodiment of the present invention.

Referring to FIG. 1, the software management apparatus may include a plurality of user terminals 100 and a management apparatus 200 connected through a network. Although, in the description, the network is depicted as a private network such as an intranet, the present invention is not limited thereto. A server agent installed in the management apparatus 200 collects information regarding the user terminals 100 and software installation on the basis of client agents installed on the user terminals 100, and controls the user terminals 100.

To be more specific, the user terminals 100 are business computers connected through a corporate or private network. The user terminal 100 is a computing device that is connectable to the management apparatus 200 through the network and is capable of running a client agent, and may be a desktop computer, PDA, laptop computer or portable computer.

The management apparatus 200 is a server device that manages and controls the user terminals 100 connected through the network in real time. For smooth operation, the management apparatus 200 may employ a high-end microprocessor and a high-capacity data storage unit so that it can support and execute the server agent, send and receive data in real time to and from the user terminals 100, and monitor the user terminals 100 without delay.

Next, a description is given of the components constituting the whole system with reference to the drawings.

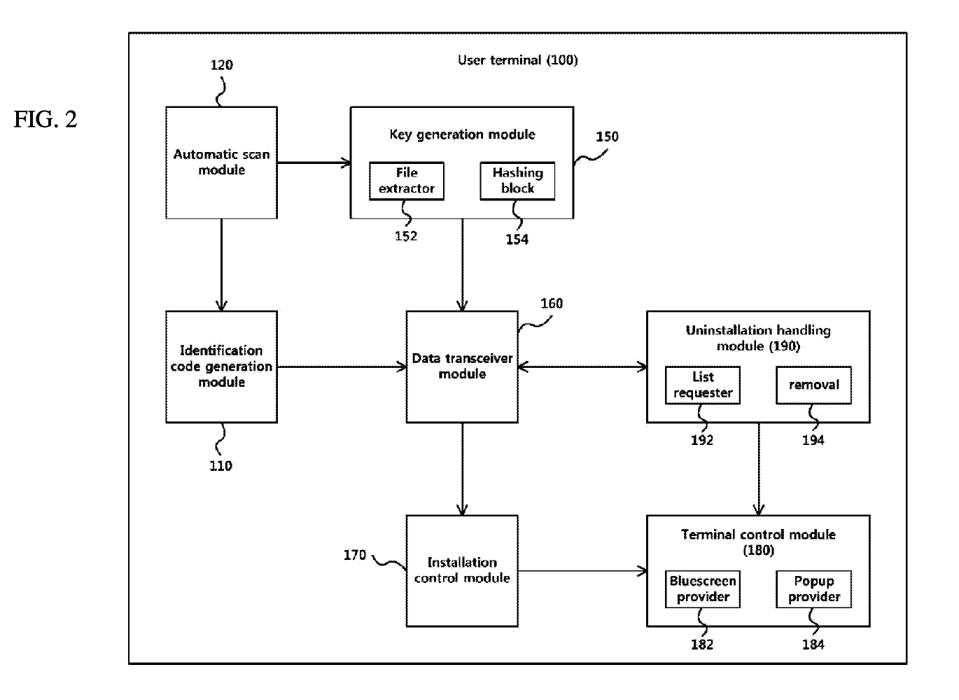

FIG. 2 is a block diagram of a user terminal 100 running a client agent according to an embodiment of the present invention.

Referring to FIG. 2, the user terminal 100 may include an identification code generation module 110 for generating a unique identification code, an automatic scan module 120 for detecting a software installation attempt, a key generation module 150 for generating, upon detection of a software installation attempt, a unique key corresponding to the software related to the installation attempt, a data transceiver module 160 for sending the identification code and unique key to the management apparatus and for receiving control information from the management apparatus, an installation control module 170 for permitting or blocking software installation according to the control of the management apparatus 200, a terminal control module 180 for blocking the use of the user terminal or outputting a notification popup, and an unstallation handling module 190 for sending a request for an uninstall list to the management apparatus and receiving an uninstall list and uninstalling software in the uninstall list.

To be more specific, the identification code generation module 110 generates a unique identification code for the user terminal so that the management apparatus may uniquely identify each user terminal on the network. Here, the identification code is generated so as to correspond to a fixed value such as a hardware address (MAC) of the user terminal or a serial number of the BIOS embedded in the main board thereof. When the automatic scan module 120 detects a software installation attempt, the identification code generation module 110 generates such an identification code.

The automatic scan module 120 detects a software installation attempt made by the user terminal. To detect a software installation attempt, the automatic scan module 120 monitors activation of a software installation process and notifies the identification code generation module 110 and the key generation module 150 of the monitoring result.

The key generation module 150 generates a unique key for the software related to an installation attempt detected by the automatic scan module 120. The unique key is data having a value uniquely identifying the software related to the installation attempt, and may be generated by hashing the installation file of the software. To achieve this, the key generation module 150 may include a file extractor 152 for extracting an installation file of the software being installed, and a hashing block 154 for generating a unique key by hashing the extracted installation file. Here, the hashing block 154 may employ a one-way hashing function such as MD5 for key generation.

The data transceiver module 160 sends the generated identification code and unique key to the management apparatus, and receives control information from the management apparatus. The management apparatus determines whether to permit or block software installation and use on the basis of the identification code and unique key, and controls the user terminal 100 through the data transceiver module 160 according to the determination result.

The installation control module 170 permits or blocks software installation under the control of the management apparatus.

The terminal control module 180 may block the use of the user terminal or output a notification popup in response to a request from the installation control module 170 or the uninstallation handling module 190. The terminal control module 180 may block the use of the user terminal or display a notification indicating unauthorized installation of software until the associated software is removed according to a policy setting. To achieve this, the terminal control module 180 may include a bluescreen provider 182 for blocking the use of the user terminal and offering an uninstall link to the software to be removed, and a popup provider 184 for outputting a popup window indicating removal of installed software or unauthorized software installation on the display screen.

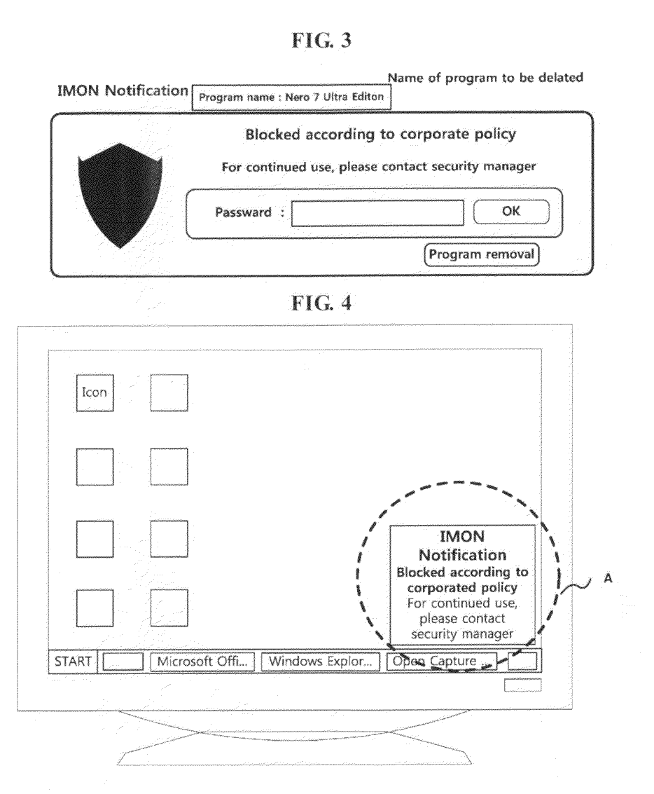

The bluescreen provider 182 displays guide information for removing the concerned software or obtaining a license and an uninstall link in the form of a bluescreen, and prohibits the use of the user terminal. Thereafter, the bluescreen provider 182 permits normal use of the user terminal when the software is removed or the license is obtained. A bluescreen is illustrated in FIG. 3.

Unlike the bluescreen provider 182 prohibiting the use of the user terminal, the popup provider 184 prohibits execution of the concerned software and displays a simple alert indicating execution blocking or removal, and permits other programs to be run. The popup provider 184 displays a popup window at a zone of the display screen. Thereafter, the popup provider 184 permits normal use of the user terminal when the software is removed or the license is obtained. A popup window is illustrated in FIG. 4.

The unstallation handling module 190 may send a request for an uninstall list to the management apparatus, receive an uninstall list, and uninstall the software in the uninstall list. This is needed to handle already installed software before installation of the client agent in the user terminal. The unstallation handling module 190 may include a list requester 192 for sending a request for an uninstall list to the management apparatus, receiving an uninstall list and identifying software in the uninstall list, and a removal executor 194 for creating and executing a process for removing the identified software. Here, the list requester 192 has to periodically provide the management apparatus with current installation information regarding the existing software already installed in the user terminal before sending an uninstall list request. The management apparatus receives the current installation information first and then receives an uninstall list request, and creates an uninstall list of software to be removed and sends the uninstall list to the requesting user terminal. The uninstall list may include, for software to be uninstalled, an identification number, title, package serial number, and the number of software pieces in the package. Preferably, the request for the uninstall list may be sent through an HTTP POST method with UTF-8 character encoding at a period of ten minutes.

Using the above described mechanisms, the client agent may uninstall already installed software. The uninstallation procedure is described in detail later with reference to the drawings.

As described above, the client agent enables the management apparatus to handle software installation attempts made by multiple user terminals and to manage software already installed in the user terminals. Next, a description is given of the management apparatus.

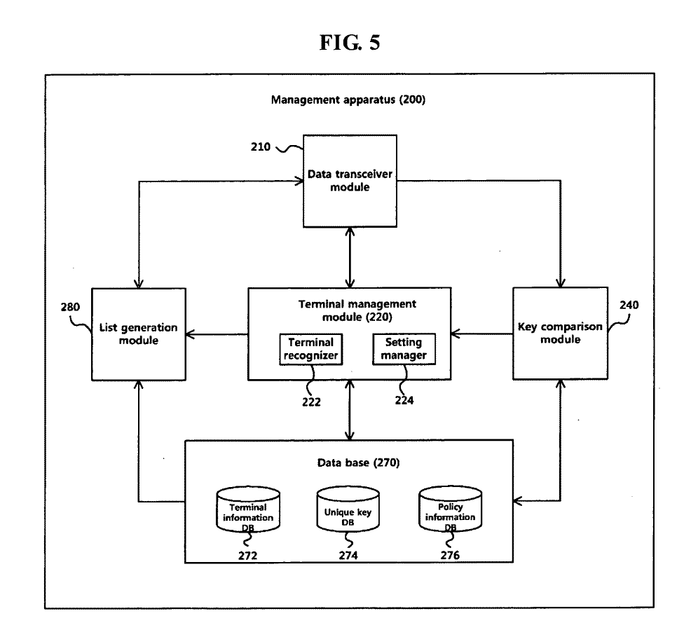

FIG. 5 is a block diagram of the management apparatus 200 according to an embodiment of the present invention.

Referring to FIG. 5, the management apparatus 200 performs software management for multiple user terminals connected through the network. The management apparatus 200 may include a data transceiver module 210 for receiving an identification code and unique key from a user terminal and sending control information to the user terminal, a terminal management module 220 for identifying a user terminal using a received identification code and unique key and determining whether to permit or block software installation, a key comparison module 240 for comparing a unique key from a user terminal with stored management information and determining whether to permit or block software installation, a database 270 for storing various information, and a list generation module 280 for receiving an uninstall list request through the data transceiver module 210, creating an uninstall list of software to be deleted and sending the uninstall list to the requesting user terminal.

To be more specific, the data transceiver module 210 is connected to the data transceiver module 160 (FIG. 2) of a user terminal, and sends and receives various information on software. The data transceiver module 210 receives an identification code and unique key from a user terminal for permitting or blocking software installation, and sends corresponding control information to the user terminal. The data transceiver module 210 receives an uninstall list request for software authorization or removal from a user terminal, and sends a corresponding uninstall list to the user terminal.

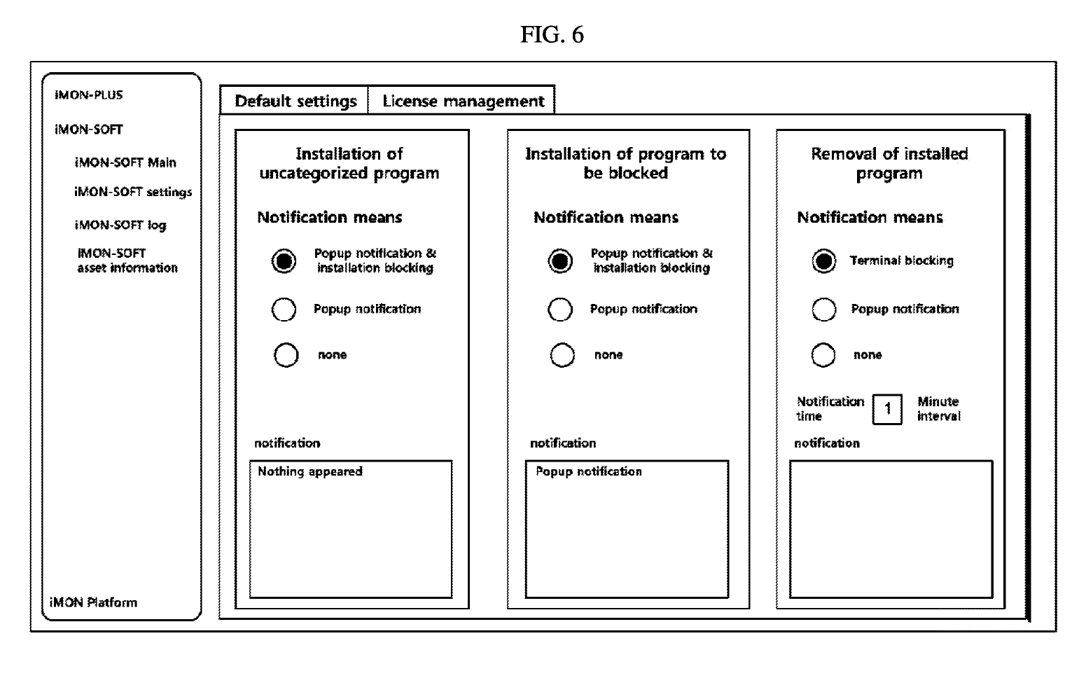

The terminal management module 220 receives an identification code and unique key from a user terminal, identifies the user terminal, and determines the assigned rights. The identification codes for all the user terminals on the network are pre-stored by the system manager in the database 270. The terminal management module 220 compares a received identification code with terminal information stored in the database 270, identifies a user terminal making a software installation attempt, and determines the right for the software installation assigned to the user terminal. To achieve this, the terminal management module 220 may include a terminal recognizer 222 for identifying a user terminal by comparing a received identification code with terminal information stored in the database 270, and a setting manager 224 for determining the right for the software installation assigned to the user terminal, and creating and offering control information for controlling the user terminal according to the determination. The setting manager 224 provides settings for installation permission or blocking to a user terminal newly added by the system manager, updates the settings assigned to each user terminal, and manages policy information defining blocking levels for software. The policy information is related to software blocking levels set by the system manager, and is managed by the management apparatus 200. A blocking level setting screen is illustrated in FIG. 6.

The database 270 stores all information created in relation to software management. The database 270 may include a terminal information DB 272 for storing information for identifying user terminals and information for software installation rights, a unique key DB 274 for storing unique keys of various software, and a policy information DB 276 for storing policy information.

The list generation module 280 receives an uninstall list request, creates an uninstall list of software to be deleted, and sends the uninstall list to the requesting user terminal. The list generation module 280 aims to handle already installed software before installation of the client agent in a user terminal, and receives current installation information regarding the existing software already installed in the user terminal in advance. In response to an uninstall list request, the list generation module 280 creates an uninstall list of software to be deleted on the basis of the right assigned to the requesting user terminal and the management information, and sends the uninstall list to the user terminal. Upon reception of the uninstall list, the user terminal uninstalls software in the uninstall list and notifies the management apparatus 200 of the result.

The management apparatus having the above configuration may handle software installation attempts made by multiple user terminals, and manage software already installed in the user terminals. Next, a description is given of software management procedures performed by the management apparatus and user terminal.

The following description is divided into a first stage before installation of a client agent in a user terminal and a second stage after installation of the client agent.

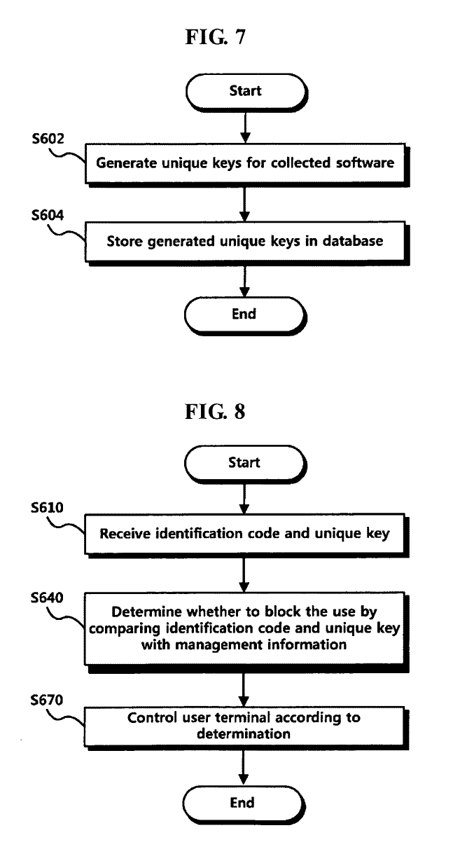

FIGS. 7 to 9 illustrate a management procedure for handling an attempt to install software in a user terminal according to an embodiment of the present invention.

The software management method of the present invention requires the management apparatus to categorize and store unique keys of multiple software products or packages to be managed in advance. It is preferable to collect information regarding software products from a software list provided by a public software organization. The management apparatus may collect software information online from a server operated by the public software organization. The system manager may collect software information offline and input the collected software information to the management apparatus.

Referring to FIG. 7, the software management method includes: generating unique keys for pieces of software collected online or offline (S602); and storing the generated unique keys in the database (S604), as preprocessing steps.

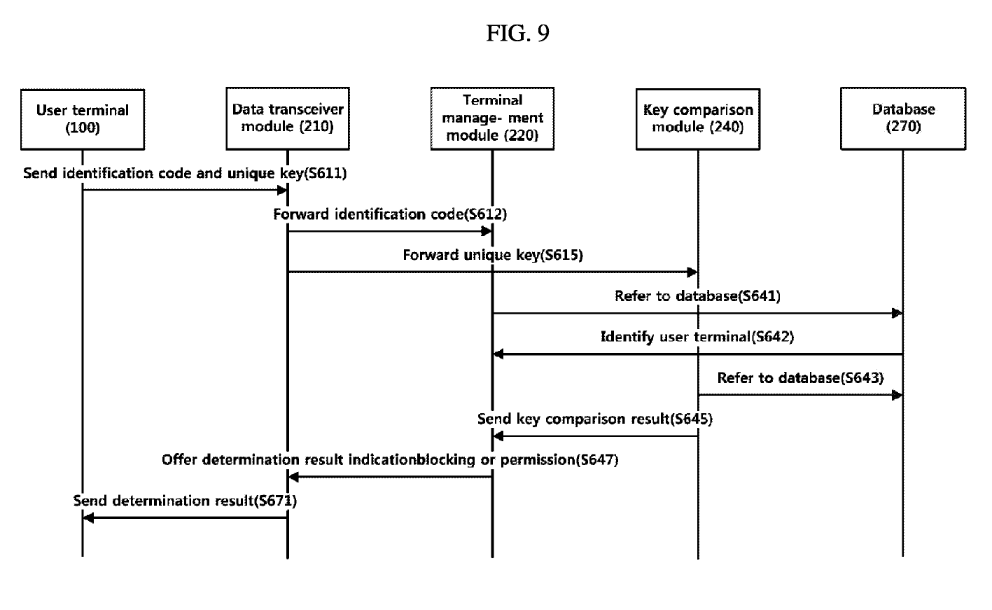

Referring to FIGS. 8 and 9, the software management method includes a procedure for handling a software installation attempt made by a user terminal controlled by the management apparatus. The procedure includes: receiving an identification code and a unique key, which is obtained by hashing the software related to an installation attempt, from a user terminal (S610); determining whether to block the use of the user terminal by comparing the identification code and unique key with management information (S640); and controlling the user terminal according to the determination (S670).

Step S610, at which the management apparatus receives an identification code and a unique key obtained by hashing the software related to an installation attempt from a user terminal, includes the following steps S611 to S615.

A user terminal 100 sends an identification code and a unique key to the data transceiver module 210 of the management apparatus 200 (S611).

The data transceiver module 210 forwards the received identification code to the terminal management module 220 (S612), and forwards the received unique key to the key comparison module 240 (S615).

Step S640, for determining whether to block the use of the user terminal by comparing the identification code and unique key with management information, includes the following steps S641 to S645.

The terminal management module 220 identifies the user terminal indicated by the identification code with reference to the management information stored in the database 270 (S641 and S642).

The key comparison module 240 determines whether to permit or block software installation by comparing the received unique key with unique keys stored in the database 270 (S643 and S645).

Here, steps S641 and S642 may be performed in parallel with, before, or after steps S643 and S645.

Step S670, for controlling the user terminal according to the determination, includes creating control information corresponding to the determination (S647) and sending the control information to the user terminal (S671). The user terminal may install the software or terminate the installation attempt according to the control information from the management apparatus. The user terminal 100 is controlled by the management apparatus 200, and subsequent steps are described later as a management procedure for the user terminal 100.

The management procedure described above is performed by the management apparatus to handle a software installation attempt made by a user terminal. Next, a description is given of a procedure to handle unauthorized software that is already installed or software that has become unauthorized after the fact because of, for example, license expiration or invalidation.

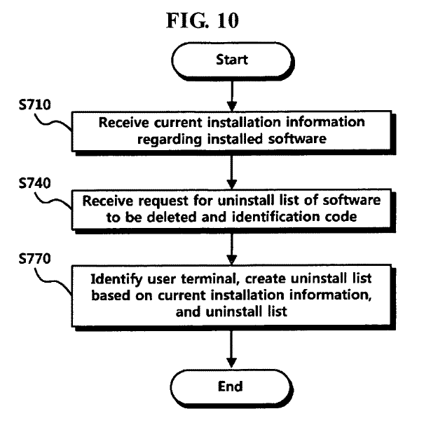

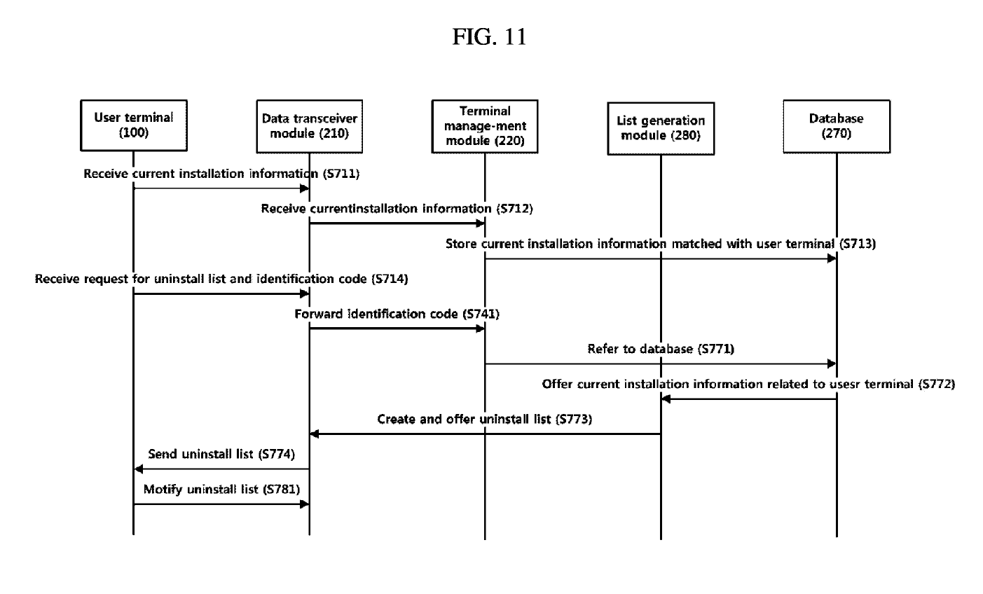

FIGS. 10 and 11 illustrate a management procedure for handling software already installed in a user terminal according to an embodiment of the present invention.

Referring to FIG. 10, the management procedure may include: receiving current installation information regarding already installed software from a user terminal (S710); receiving an uninstall list request and identification code from the user terminal (S740); and identifying the user terminal using the identification code, creating an uninstall list of software to be deleted from the user terminal on the basis of the current installation information, and sending the uninstall list to the user terminal (S770).

To be more specific, step S710, for receiving current installation information regarding already installed software from a user terminal, includes the following steps S711 to S713.

The data transceiver module 210 of the management apparatus receives current installation information regarding already installed software from a user terminal 100 (S711).

The data transceiver module 210 forwards the current installation information to the terminal management module 220 (S712).

The terminal management module 220 causes the database 270 to store the current installation information in relation with the sending user terminal 100 (S713).

Step S740, for receiving an uninstall list request and identification code from the user terminal, includes the following steps S741 and S742.

The user terminal 100 sends a request for an uninstall list of software to be deleted and the identification code to the data transceiver module 210 (S741).

The data transceiver module 210 forwards the received identification code to the terminal management module 220, which then causes the current installation information related to the requesting user terminal to be provided to the list generation module 280 (S742).

Step S770, for identifying the user terminal, creating an uninstall list of software to be deleted, and sending the uninstall list to the user terminal, includes the following steps S771 to S774.

The terminal management module 220 identifies the user terminal using the received identification code, and offers the current installation information related to the identified user terminal retrieved from the database 270 to the list generation module 280 (S771 and S772).

The list generation module 280 creates an uninstall list of software to be deleted on the basis of the current installation information, and sends the created uninstall list to the data transceiver module 210 (S773).

The data transceiver module 210 transmits the uninstall list to the requesting user terminal (S774).

Thereafter, the user terminal 100 uninstalls the software in the uninstall list, and notifies the management apparatus of the result (S781). Detailed steps are described later as a management procedure for the user terminal 100.

As described above, for a software installation attempt and pre-installed unauthorized software, the software management apparatus may block the use of the corresponding user terminal, prohibit software installation, or remove the software. Next, a description is given of a management procedure performed by a user terminal controlled by the management apparatus with reference to the drawings.

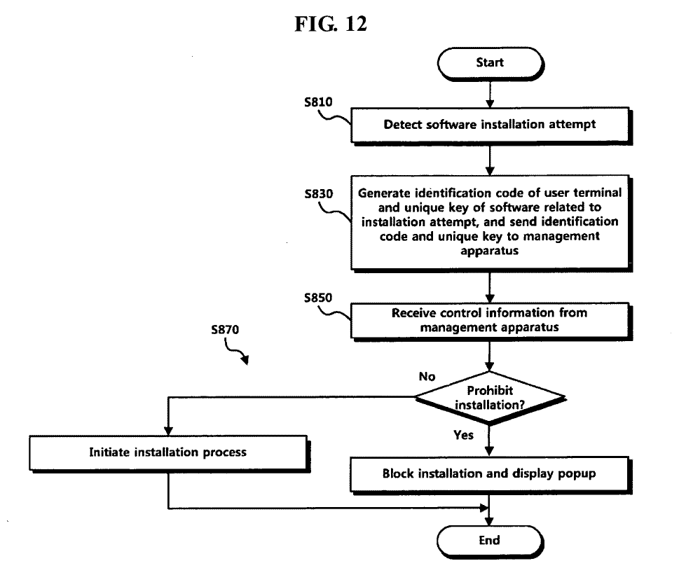

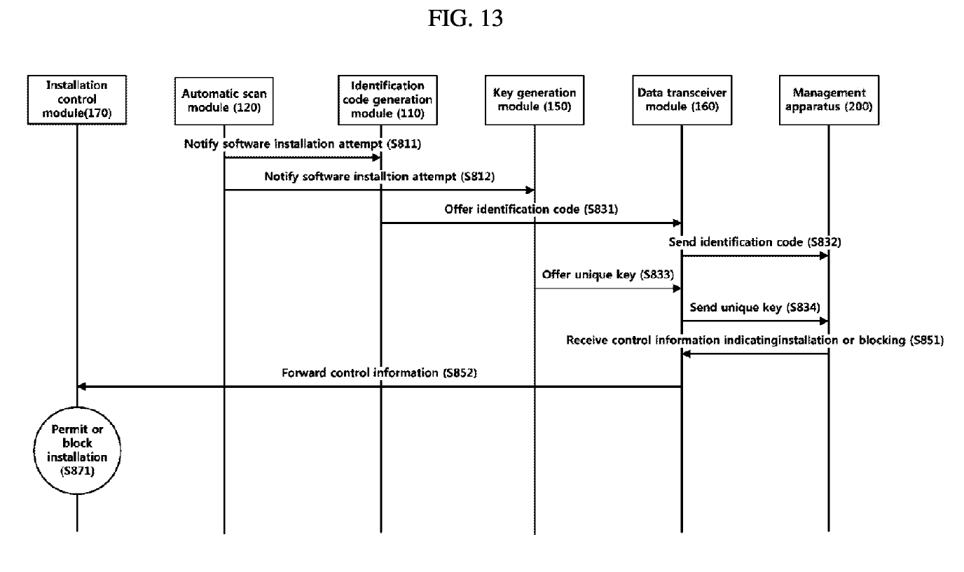

FIGS. 12 and 13 illustrate a management procedure for handling an attempt to install software in a user terminal that is controlled by the management apparatus according to an embodiment of the present invention.

Referring to FIG. 12, the management procedure of a user terminal may include: detecting a software installation attempt (S810); generating an identification code of the user terminal and a unique key of software related to the installation attempt, and sending the identification code and unique key to the management apparatus (S830); receiving control information from the management apparatus (S850); and installing the software or prohibiting the installation attempt according to the control information from the management apparatus (S870).

To be more specific, step S810, for detecting a software installation attempt, includes the following steps S811 and S812.

The automatic scan module 120 monitors activation of a software installation process and notifies a software installation attempt to the identification code generation module 110 and the key generation module 150 (S811 and S812).

Step S830, for generating and sending the identification code and unique key to the management apparatus, includes the following steps S831 to S834.

The identification code generation module 110 generates an identification code of the user terminal and offers the identification code to the data transceiver module 160 (S831), and the data transceiver module 160 sends the identification code to the management apparatus (S832). Here, the identification code is generated so as to correspond to a fixed value such as a hardware address (MAC) of the user terminal or a serial number of the BIOS embedded in the main board thereof.

The key generation module 150 generates a unique key corresponding to the installation file of the software related to the installation attempt and offers the unique key to the data transceiver module 160 (S833), and the data transceiver module 160 sends the unique key to the management apparatus (S834).

Step S850, for receiving control information from the management apparatus, includes the following steps S851 and S852. The management apparatus 200 identifies the user terminal corresponding to the identification code, determines whether the software indicated by the unique key is permitted for installation at the user terminal, and sends control information corresponding to the determination to the user terminal.

The data transceiver module 160 receives control information from the management apparatus (S851), and forwards the control information to the terminal control module 180 (S852).

Step S870, for installing the software or prohibiting the installation attempt according to the control information, includes the following step S871.

The terminal control module 180 causes the software to be installed by activating the installation process or prohibits the installation attempt according to the control information (S871). Here, the policy set by the management apparatus 200 may be reflected. For example, the terminal control module 180 may display a bluescreen to prohibit the use of the user terminal (a first policy), or may display a notification popup to allow the use of the user terminal (a second policy).

As described above, for a software installation attempt, the user terminal may be blocked, prohibit the installation attempt, or remove the software related to the installation attempt. Next, a description is given of a management procedure for handling already installed software with reference to the drawings.

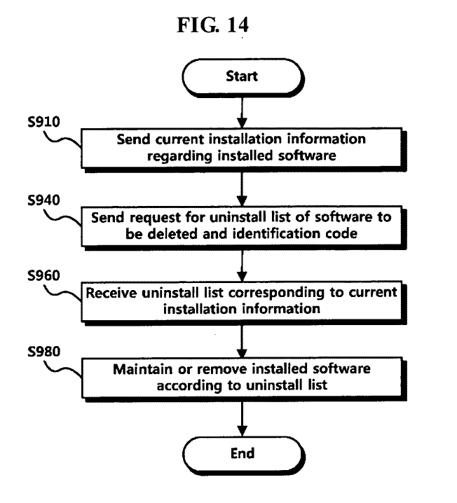

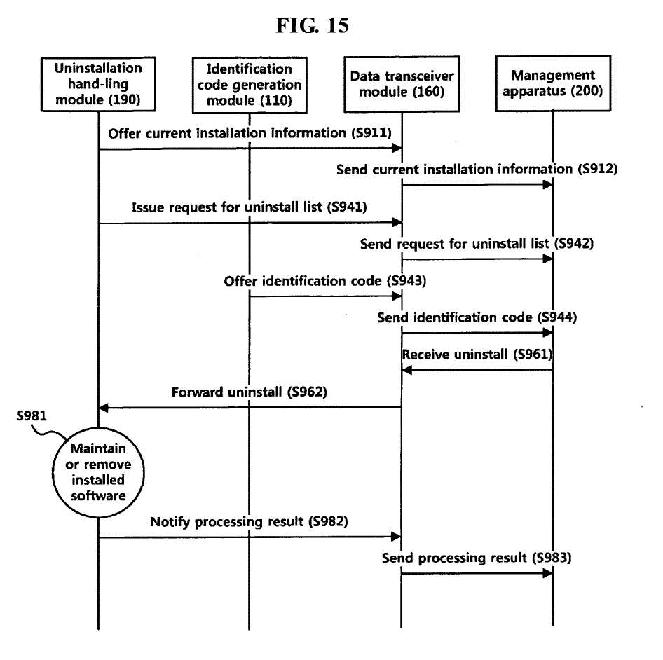

FIGS. 14 and 15 illustrate a management procedure for handling software already installed in a user terminal that is controlled by the management apparatus according to an embodiment of the present invention.

Referring to FIG. 14, the management procedure may include: sending current installation information regarding already installed software to the management apparatus (S910); sending a request for an uninstall list of software to be deleted and the identification code to the management apparatus (S940); receiving an uninstall list corresponding to the current installation information from the management apparatus (S960); and maintaining or removing the installed software according to the uninstall list (S980).

To be more specific, step S910, for sending current installation information regarding already installed software to the management apparatus, includes the following steps S911 and S912.

The unstallation handling module 190 collects information regarding already installed software in the user terminal (current installation information) and offers the current installation information to the data transceiver module 160 (S911), and the data transceiver module 160 sends the current installation information to the management apparatus 200 (S912).

Step S940, for sending a request for an uninstall list of software to be deleted and the identification code to the management apparatus, includes the following steps S941 and S944.

The unstallation handling module 190 sends a request for an uninstall list of software to be deleted to the data transceiver module 160 (S941), and the data transceiver module 160 transmits the request to the management apparatus 200 (S942). Here, the uninstall list is a list of software to be processed by the user terminal, and is a file in INI format. An uninstall list is illustrated in Table 1.

TABLE 1
INI file

| | |
|---|---|
| [item_*] | |
| identification number=N | “item sequence number” |
| SoftwareName=Adobe Photoshop CS | “software name” |
| [General] | |
| PackageSeq=104 | “unique value of package” |
| itemNumber=1 | “number of software items in |
| | package” |

The uninstall list illustrated in Table 1 enables treating, in addition to a single piece of software, multiple independent software pieces or items constituting a single package as a group. This may prevent software that is distributed as a package from being mistaken for different software. In Table 1, the parameter ‘PackageSeq’ is used for grouping software as a package, and the parameters ‘identification number’ and ‘SoftwareName’ are used to identify a specific software item.

The identification code generation module 110 offers the identification code of the mobile terminal to the data transceiver module 160 (S943), and the data transceiver module 160 sends the identification code to the management apparatus 200 (S944). Here, the identification code may be in the INI file format.

Step S960, for receiving an uninstall list corresponding to the current installation information from the management apparatus, includes the following steps S961 and S962.

The management apparatus 200 determines the user terminal indicated by the identification code and the right assigned thereto, creates an uninstall list on the basis of current installation information, and sends the uninstall list to the data transceiver module 160 of the user terminal (S961), and the data transceiver module 160 forwards the received uninstall list to the unstallation handling module 190 (S962).

Step S980, for maintaining or removing the installed software according to the uninstall list, includes the following steps S981 to S983.

The unstallation handling module 190 maintains or removes the installed software according to the received uninstall list (S981).

The unstallation handling module 190 offers the processing result to the data transceiver module 160 (S982), and the data transceiver module 160 sends the processing result to the management apparatus 200 (S983).

Thereafter, the user terminal may display a notification popup.

As described above, the user terminal of the present invention may delete already installed software.

The software management apparatus and method of the present invention may be implemented as computer programs and may be stored in various computer readable storage media such as a CD-ROM, RAM, ROM, floppy disk, hard disk, and magneto-optical disc.

While the present invention has been particularly shown and described with reference to exemplary embodiments thereof, it will be understood by those skilled in the art that various changes in form and details may be made therein without departing from the spirit and scope of the invention as defined by the appended claims.

1. A software management method for a management apparatus controlling a plurality of user terminals, comprising:
receiving an identification code and a unique key that is obtained by hashing software related to an installation attempt from a user terminal;
determining whether to permit or prohibit installation of the software related to the installation attempt by comparing the identification code and unique key with management information; and
controlling the user terminal to install or remove the software according to the determination.

2. The software management method of claim 1, wherein the unique key is a hash value obtained by applying a one-way hashing function to an installation file of the software.

3. The software management method of claim 1, wherein the identification code corresponds to a hardware address (MAC) or a BIOS serial number of the user terminal.

4. The software management method of claim 1, wherein the management information comprises information regarding the type and quantity of software available for installation for each user terminal.

5. The software management method of claim 1, further comprising:
generating unique keys for multiple pieces of software to be managed, before receiving an identification code and a unique key from a user terminal; and
storing the generated unique keys in a database.

6. The software management method of claim 1, wherein determining whether to permit or prohibit installation of the software related to the installation attempt comprises:
identifying the user terminal associated with the identification code;
identifying the type of the software on the basis of the unique key; and
checking whether to permit or prohibit installation of the software by comparing the identification results with the management information related to the user terminal.

7. The software management method of claim 6, wherein checking whether to permit or prohibit installation of the software further comprises determining to permit installation of the software when the identified type indicates update.

8. The software management method of claim 1, further comprising:
receiving current installation information regarding already installed software from a user terminal;
receiving a request for an uninstall list of software to be deleted from the user terminal and an identification code of the user terminal; and
identifying the user terminal using the identification code, creating an uninstall list on the basis of the current installation information, and sending the uninstall list to the user terminal.

9. The software management method of claim 8, wherein the current installation information is periodically received, and the uninstall list is sent and received through an HTTP POST method with UTF-8 character encoding.

10. The software management method of claim 8, wherein the uninstall list is an INI file that contains information regarding specific software including the sequence number, name, package identifier, and number of software items in the package.

11. The software management method of claim 8, wherein identifying the user terminal and creating an uninstall list comprises:
identifying the user terminal using the received identification code;
creating an uninstall list of software to be deleted by comparing the management information related to the identified user terminal with the current installation information; and
sending the created uninstall list to the user terminal.

12. A software management method for a user terminal that is controlled by a management apparatus, comprising:
detecting a software installation attempt;
generating an identification code of the user terminal and a unique key of software related to the installation attempt, and sending the identification code and unique key to the management apparatus; and
installing the software related to the installation attempt or prohibiting the installation attempt according to control information from the management apparatus.

13. The software management method of claim 12, wherein generating an identification code and a unique key comprises:
detecting a process for installing the software;
extracting an installation file of the software; and
generating the unique key by hashing the installation file.

14. The software management method of claim 12, further comprising displaying, when the installation attempt is prohibited, a notification popup indicating an installation abortion notification according to policy information from the management apparatus.

15. The software management method of claim 12, further comprising:
sending current installation information regarding already installed software to the management apparatus;
sending a request for an uninstall list of software to be deleted and the identification code to the management apparatus;
receiving an uninstall list corresponding to the current installation information from the management apparatus; and
maintaining or removing the installed software according to the uninstall list.

16. The software management method of claim 15, further comprising notifying the management apparatus of the result of software removal.

17. The software management method of claim 15, further comprising:
receiving policy information related to usage restriction from the management apparatus after maintaining or removing the installed software; and
displaying a bluescreen to prohibit the use of the user terminal, or displaying a notification popup indicating prohibition of the use of the software according to the received policy information.

18. A software management apparatus for controlling a plurality of user terminals, comprising:
a data transceiver module receiving an identification code and unique key from a user terminal, and sending control information for software installation permission or rejection to the user terminal;
a terminal management module identifying a user terminal indicated by a received identification code and unique key, and determining whether to permit or block software installation; and
a key comparison module comparing a unique key from a user terminal with management information stored in a database, and determining whether to permit or block software installation.

19. The software management apparatus of claim 18, wherein the terminal management module comprises:
a terminal recognizer identifying a user terminal by comparing the received identification code with terminal information stored in the database; and
a setting manager determining the right for software installation assigned to the identified user terminal, and offering control information for controlling the user terminal according to the determination.

20. The software management apparatus of claim 18, wherein the database comprises:
a terminal information DB storing terminal information for identifying user terminals and information for software installation permission and rejection;
a unique key DB storing unique keys of various software; and
a policy information DB defining blocking levels of software.

21. The software management apparatus of claim 18, further comprising a list generation module receiving a request for an uninstall list of software to be deleted through the data transceiver module, creating an uninstall list with reference to the database, and sending the uninstall list to the requesting user terminal.

22. A user terminal controlled by a management apparatus, comprising:
an identification code generation module generating a unique identification code of the user terminal;
an automatic scan module detecting a software installation attempt;
a key generation module generating, upon detection of a software installation attempt, a unique key corresponding to the software related to the installation attempt;
a data transceiver module sending the identification code and unique key to the management apparatus, and receiving control information for software installation permission or rejection from the management apparatus; and
an installation control module permitting or blocking software installation according to the control information from the management apparatus.

23. The user terminal of claim 22, wherein the key generation module comprises:
a file extractor extracting an installation file of the software; and
a hashing block generating the unique key by hashing the extracted installation file.

24. The user terminal of claim 23, wherein the hashing block generates the unique key using a one-way hashing function.

25. The user terminal of claim 22, further comprising a terminal control module that comprises:
a bluescreen provider blocking the use of the user terminal and providing a means for deleting the software; and
a popup provider outputting a popup window indicating blocking the use of the software on the display screen.

26. The user terminal of claim 22, wherein the identification code corresponds to a hardware address (MAC) or a BIOS serial number of the user terminal.

27. The user terminal of claim 22, further comprising an uninstallation handling module that comprises:
a list requester sending current installation information and a request for an uninstall list of software to be deleted to the management apparatus, receiving an uninstall list and identifying software to be deleted using the uninstall list; and
a removal executor deleting the software identified by the list requester.

28. The user terminal of claim 27, wherein the uninstall list is sent and received through an HTTP POST method with UTF-8 character encoding at a period of ten minutes.

29. The user terminal of claim 27, wherein the uninstall list contains information regarding specific software including the sequence number, name, package identifier, and number of software items in the package.
